(19) United States
(12) Patent Application Publication
(10) Pub. No.: US 2006/0248103 A1
(43) Pub. Date: Nov. 2, 2006

(54) Method of detecting memory leaks in software applications

(75) Inventor: Aaron J. Belcher, Shoreline, WA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/119,256

(22) Filed: Apr. 29, 2005

(51) Int. Cl. G06F 7/00

(52) U.S. Cl. 707/101

(57) ABSTRACT

A method for detecting memory leaks includes initializing memory for a process under a load. Bits in a bitmap are then set/reset during a time interval after initialization of the memory. Each bit is set/reset at a location in the bitmap that uniquely corresponds to an address of a memory allocation/deallocation of the process stopping the load. Memory allocations corresponding to remaining bits in the bitmap are listed to identify the leaked memory. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates generally to data processing systems; more specifically, to software applications and software tools for optimizing the performance of applications and processes designed to run on a data processing system.

### BACKGROUND OF THE INVENTION

Most modern computer operating systems include a subsystem which provides high-level memory management functions that make it easy for applications to build dynamic data structures, provide compatibility with previous versions of the operating system, and create buffers and temporary placeholders for system functions. These memory management functions typically return handles and pointers to blocks of memory that are allocated at run time and managed by an entity called a heap. As is well-known, the primary function of a heap is to efficiently manage the memory and address space of a process for an application.

In order to optimize the performance of software applications that run on a particular computer system, it is useful for a software developer to determine how efficiently their application uses memory, and whether memory leaks occur during execution. A “memory leak” occurs when a process such as an application or a service allocates memory (heap memory) and either neglects to free it to the operating system. This can occur when an application or service loses track of memory or keeps spawning new operations that allocate memory but never free the memory by completing their task. Memory leaks are a common problem in software applications that can cause the application to slow down over time. Memory leaks in a long-running program, such as a server application that is designed to run for weeks or months at a time, are a particularly serious problem, because it can result in memory fragmentation and the accumulation of large numbers of mostly garbage-filled pages in real memory and page space.

A number of different techniques have been developed for detecting memory leaks. Some of the more common types of approaches to detecting memory leaks involve: a comparison of memory “snapshots” taken before and after leaky operations; detection of allocated memory space that has not been accessed recently; and categorizing memory allocations to create a stack trace of code allocating the memory. An example of this latter approach is found in U.S. Pat. No. 6,718,485, which discloses a software tool capable of detecting memory leaks wherein a memory block that has been allocated, and has not been freed, cannot be reached by following a chain of pointers starting from the stack and going through other reachable allocated blocks.

By way of further example, U.S. Pat. No. 6,782,462 teaches a system and method for tracking memory leaks in which a user sets a memory tracking flag that notifies the system to track memory allocations and de-allocations. A method and system for detecting memory leaks in an object-oriented environment during real time trace processing is described in U.S. Pat. No. 6,658,652. An analysis procedure for catching memory leak errors is also disclosed in U.S. Pat. No. 6,823,507. In addition, IBM's Rational Purify software product keeps track of memory that is not allocated to your program, memory that is allocated but uninitialized, memory that is both allocated and initialized, and memory that has been freed after use but still initialized.

Although many of these prior art approaches have been successfully used to track down memory leaks in an application, each is not without its drawbacks. For example, memory leak detection techniques that rely upon memory snapshots or traces usually need to keep track of the path associated with every memory allocation. Often times, however, the tracking paths can be larger than the memory allocations itself, which can be a significant burden to the application running, causing the application to slow down or even fail. False positive results are also a common occurrence with many prior art techniques for detecting memory leaks.

Thus, what is a needed is an improved method for detecting memory leaks which overcome the problems inherent in the prior art.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a graph of memory usage by a process under a load operating in accordance with one embodiment of the present invention.

FIG. 2 is a diagram of a heap address showing bit field partitions in accordance with one embodiment of the present invention.

FIG. 3 is a flowchart diagram that illustrates a method of tracking down memory leaks in accordance with one embodiment of the present invention.

### DETAILED DESCRIPTION

A novel method of tracking down memory leaks in a process running on a computer is described. In the following description specific details are set forth, such as bit field sizes, data structures, binary settings, etc., in order to provide a thorough understanding of the present invention. However, persons having ordinary skill in the networking arts will appreciate that these specific details may not be needed to practice the present invention.

According to one embodiment of the present invention, memory leaks are detected as stale memory or memory that has not been accessed in a given time period through the use of a large bitmap. The size of the bitmap is determined by the number of possible addresses that can be allocated. For example, in the standard 32-bit addressing scheme of the Intel family of processors and Windows Operating System (OS), there are approximately 17 million different addresses that may returned when an application allocates a chunk of memory. Thus, in the case of 32-bit addressing, the bitmap is approximately 17 million bits long. Each time a memory allocation occurs during a specific time window in the execution life of a process, a single bit in the bitmap is set (e.g., to “1”). The bit that is set uniquely corresponds to the address (e.g., heap address) returned by the computer's operating system in response to the memory allocation. This bit is reset (e.g., to “0”) upon deallocation. As will be seen, the time window is chosen so as to keep a record of stale memory that was allocated, but never deallocated, following process initialization.

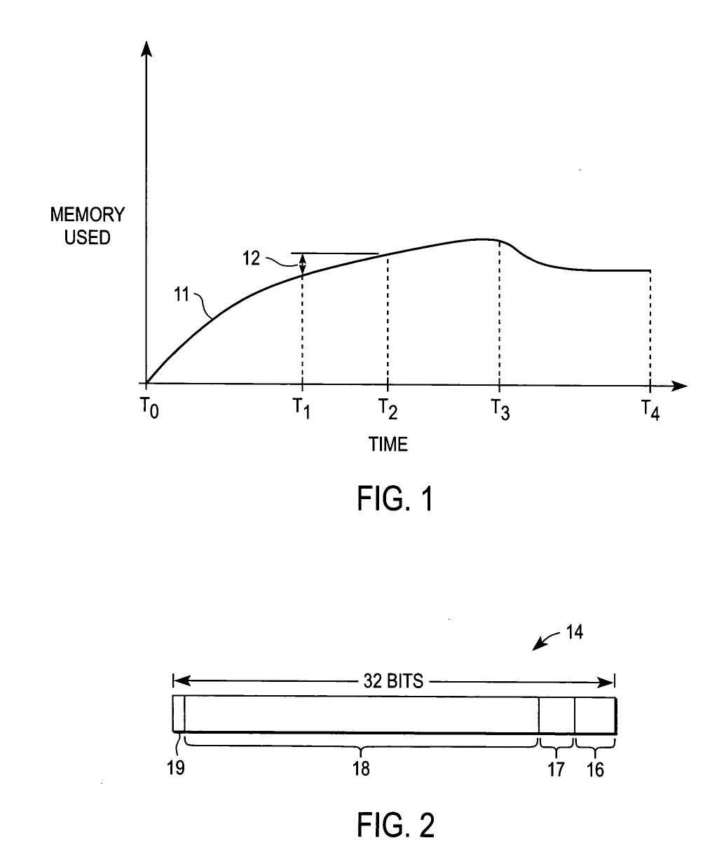

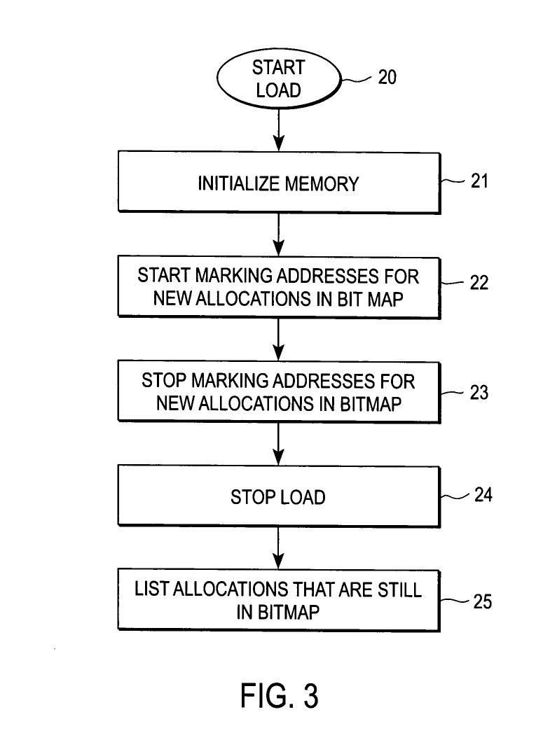

FIG. 1 is a graph that shows the memory usage of an exemplary process under a load that is leaking memory. An embodiment of the present invention is shown in the flowchart of FIG. 3, which embodiment will be described with reference to graph of FIG. 1. (It should be understood that the graph of FIG. 1 is conceptual in nature and not to scale. That is, the relative size of the various time intervals shown in the graph is not necessarily indicative of actual durations in a given process. For example, even though the graph of FIG. 1 shows the time interval between times T₂ and T₃ to be larger than the interval between T₁ and T₂, in a given process the actual time interval between T₁ and T₂ may in fact be much longer than the actual time interval between T₂ and T₃.)

The load test starts at time T₀, when the application begins running on one or more processors of the computer system. Immediately following the start of the load test (oval 20 in FIG. 3), the application begins initializing some amount of memory, as shown by the increase in memory usage over time of curve 11. At a point in time prior to time T₁, the application finishes initializing its memory (block 21). Time T₁ begins the marking of bit positions in the bitmap that correspond to the addresses of each new memory allocation (block 22). The process of marking bit positions in the bitmap that correspond to addresses for each new memory allocation continues until time T₂ (block 23). During the time interval from T₁ until T₂ every time a new memory allocation happens a bit in the bitmap is set (e.g., to “1”) at a bit location corresponding to the memory address returned by the OS. Conversely, each time a deallocation occurs during the time interval from T₁ until T₂, the previously set bit at the location in the bitmap corresponding to the deallocated memory address is reset (e.g., to “0”). The net result of the above bitmap marking algorithm is that at time T₂, the bitmap will include a record of every memory allocation that occurred during the time window from T₁ until T₂ that was not deallocated.

It should be understood that the bitmap is initialized to all zeros prior to time T₁. Alternatively, the bitmap may be initialized to all “1”s, with the setting/resetting of the bitmap bit positions causing a change in binary value to a “0”/“1”, respectively.

Continuing with the above example, at time T₃ the load stops (block 24). Shortly thereafter, memory used for any outstanding requests gets deallocated, which is indicated in the graph of FIG. 1 by the drop or dip in curve 11 after at time T₃.

After deallocation of all outstanding memory requests, curve 11 flattens out, such that at time T₄ the application developer or investigator can produce a list of all allocations that remain in the bitmap (block 25) along with the size and contents of each memory allocation. The bits that remain set in the bitmap at time T₄ correspond to stale memory that was not allocated during the initialization of the process (i.e., leaked memory). In FIG. 1, the memory leaks are reflected by arrow 12, which indicates the difference in memory usage between times T₁ and T₂. The information about the leaked memory can be used to improve the efficiency and performance of the application.

To reiterate, the net result of the above algorithm is that at time T₂, the bitmap will include a record of every memory allocation that occurred during the time window from T₁ until T₂ that was not deallocated. Practitioners in the art will appreciate that by stopping new allocation tracking at time T₂ and allowing the process to continue running under load until time T₃ insures that the allocations captured in the interval from T₁ to T₂ represent stale memory, rather than memory used for any outstanding requests. In other words, if the time between T₂ to T₃ were too short, there would be a risk of tracking in the bitmap memory that is not actually leaked. It is further appreciated that the time period between T₂ to T₃ is set by the user depending upon the particular application being investigated.

FIG. 2 illustrates a 32-bit heap address 14 showing bit field partitions in accordance with one embodiment of the present invention. As described previously, memory addresses are converted or mapped to unique bit positions in a bitmap during the marking part of the load. When memory is allocated during this time period, a single bit at a bit position in the bitmap that uniquely corresponds to the address is set. When memory is deallocated the corresponding bit in the bitmap is reset.

In a conventional 32-bit addressing scheme, since each heap allocation happens on an 8 byte boundary, the three bits in bit field 16 are always zero. In the presently described embodiment the bits in field 16 are therefore ignored. Similarly, the single bit in field 19 is ignored for purposes of mapping addresses to the bitmap since addresses with this bit set are reserved for kernel memory. The address bits used in the conversion or mapping process are the three bits in field 17 and the remaining 24 bits in bit field 18. The address bits in field 18 are converted to a value (i.e., between 0 and 16777215) that identifies a particular byte in the bitmap. The value of the 3-bit binary field 17 determines with bit in that byte is set. One straightforward technique for computing the bit location in the bitmap is to divide the heap address by eight: the product of the division identifies the byte in the bitmap to be updated, and the remainder identifies the particular bit in that byte to be set.

To better understand the above conversion algorithm, consider a simple example where the heap address of a memory allocation is:

0000000000000000000000101001000.

In this example, the bits in field 18 have a value of five, and the bits in field 17 have a value of one, which means that bit position one of byte number five of the bitmap is set to a “1” in response to this particular memory allocation. Deallocation of that memory results in that same bit (i.e., bit position one of byte number five of the bitmap) being reset to “0”.

The method of the present invention is also applicable to other types of addressing schemes. For example, in a 64-bit addressing scheme the bitmap is much larger, but the above conversion algorithm is still applicable. It is also appreciated that other embodiments may utilize different conversion algorithms. Still other embodiments may mark more than one bit position in the bitmap in correspondence with a specific memory allocation.

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer (e.g., a server) to a requesting computer (e.g., a customer or client) by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

I claim:

1. A method of detecting memory leaks comprising:
initializing memory for a process under a load;
setting/resetting bits in a bitmap during a time interval after initialization of the memory, each bit being set/reset at a location in the bitmap that uniquely corresponds to an address of a memory allocation/deallocation of the process;
stopping the load;
listing memory allocations corresponding to remaining bits in the bitmap.

2. The method of claim 1 further comprising:
deallocating memory used for outstanding requests after the load has stopped.

3. The method of claim 1 wherein the setting/resetting of the bits comprises:
converting a first bit field in the address to a byte location of the bitmap; and
converting a second bit field in the address to a bit position of the byte location.

4. The method of claim 1 wherein the mapping comprises:
dividing a portion of the address by eight, a product of the division specifying a byte in the bitmap, with a remainder of the division specifying a bit in the byte.

5. A method of detecting memory leaks comprising:
initializing memory for a process under a load;
mapping a heap address of each memory allocation that occurs during a time interval after initialization of the memory of the process into a single bit of a bitmap, the single bit having a position in the bitmap that uniquely corresponds to the heap address, the single bit being reset upon deallocation of memory at the heap address;
stopping the load after the time interval has ended;
listing memory allocations corresponding to remaining bits in the bitmap a period of time after the load has stopped.

6. The method of claim 5 wherein the mapping comprises:
dividing a portion of the heap address by eight, a product of the division specifying a byte in the bitmap, with a remainder of the division specifying a bit position in the byte, wherein the single bit is located at the bit position.

7. The method of claim 5 wherein the mapping comprises:
converting a first bit field in the heap address to a byte location of the bitmap; and
converting a second bit field in the heap address to a bit position of the byte location.

8. The method of claim 5 further comprising:
deallocating memory used for outstanding requests after the load has stopped.

9. A computer program product comprising a computer useable medium and computer readable code embodied on the computer useable medium, execution of the computer readable code causing a processor-based device to:
map a heap address of each memory allocation that occurs during a time interval after initialization of memory for a process under a load into a single bit of a bitmap, the single bit having a position in the bitmap that uniquely corresponds to the heap address, the single bit being reset upon deallocation of memory at the heap address;
list memory allocations corresponding to remaining bits in the bitmap a period of time after the load has stopped.

10. The computer program product of claim 11 wherein execution of the computer readable code further causes the processor-based device to:
stop the load a predetermined time period after the time interval has elapsed; and
deallocate memory used for outstanding requests after the load has stopped, the list of the memory allocations being produced after deallocation of the memory used for the outstanding requests.

11. The computer program product of claim 11 wherein execution of the computer readable code further causes the processor-based device to:
convert a first bit field in the heap address to a byte location of the bitmap; and
convert a second bit field in the heap address to a bit position of the byte location.

12. The computer program product of claim 11 wherein execution of the computer readable code further causes the processor-based device to:
divide a portion of the heap address by eight, a product of the division specifying a byte in the bitmap, with a remainder of the division specifying a bit in the byte.

13. A computer program product comprising a computer useable medium and computer readable code embodied on the computer useable medium, execution of the computer readable code causing a processor-based device to:
initialize memory for a process under a load;
map a heap address of each memory allocation that occurs during a time interval after initialization of memory for a process under a load into a single bit of a bitmap, the single bit having a position in the bitmap that uniquely corresponds to the heap address, the single bit being reset upon deallocation of memory at the heap address;
stop the load after the time interval has ended;
deallocate memory used for outstanding requests after the load has stopped;
list memory allocations corresponding to remaining bits in the bitmap after deallocation of the memory used for the outstanding requests.

14. The computer program product of claim 15 wherein execution of the computer readable code further causes the processor-based device to:
convert a first bit field in the heap address to a byte location of the bitmap; and
convert a second bit field in the heap address to a bit position of the byte location.

15. Apparatus for detecting memory leaks comprising:
a memory;
a bitmap;
means for setting/resetting bits in the bitmap during a time interval after initialization of the memory by a process under a load, each bit being set/reset at a location in the bitmap that uniquely corresponds to an address of a memory allocation/deallocation of the process; and
means for listing memory allocations corresponding to remaining bits in the bitmap after the load has stopped.
